(19) United States
(12) Patent Application Publication
(10) Pub. No.: US 2023/0214475 A1
(43) Pub. Date: Jul. 6, 2023

(54) SYSTEMS AND METHODS FOR COARSE WAVELENGTH DIVISION MULTIPLEXING SECURITY

(71) Applicants: Duke Energy Corporation, Charlotte, NC (US); A-PLUS Community Solutions, Inc., Roswell, GA (US)

(72) Inventors: Ron K. Wages, Waxhaw, NC (US); Larry J. Morrow, Nashville, GA (US)

(21) Appl. No.: 18/057,442

(22) Filed: Nov. 21, 2022

Related U.S. Application Data
(60) Provisional application No. 63/266,304, filed on Dec. 31, 2021.

(51) Int. Cl. G06F 21/33

(52) U.S. Cl. CPC G06F 21/33

(57) ABSTRACT

Systems, apparatuses, methods, and computer program products are disclosed for wavelength division multiplexing (WDM) security. An example method includes transmitting, by a control system, an authentication request to an active device in a fiber optic network, receiving, by the control system, a message from the active device, the message containing a unique identifier and an authentication key, and performing, by the control system, one or more authentication operations using the unique identifier and the authentication key. The method further includes, in an instance in which the active device is fails to be authenticated, transmitting, by the control system, an encryption key change message to the active device, but in an instance in which the active device is authenticated, transmitting, by the control system, a message to the active device authorizing the active device to communicate. Corresponding apparatuses and computer program products are also disclosed.

### CROSS REFERENCE TO RELATED APPLICATIONS

The present application claims the benefit of U.S. Provisional Application No. 63/266,304, filed Dec. 31, 2021, which is hereby incorporated by reference in its entirety.

### TECHNOLOGICAL FIELD

The present disclosure relates in general to the field of electrical power distribution, and more specifically, to systems for enhancing security of data communications across a fiber optic network.

### BACKGROUND

Modern power distribution grids include many generation and transmission resources used to provide power to different types of user loads. Generation and transmission resources may include generators, transmission lines, substations, transformers, etc.

FIG. 1 is a simplified block diagram illustrating an example electrical power distribution environment 100. Referring to FIG. 1, electric power may be generated at a power generation facility 110 for distribution to users 140A-140N that consume the generated electric power. Examples of power generation facilities 110 include facilities which generate electricity from fossil fuels (e.g., coal, petroleum, and/or natural gas), solar energy, geothermal energy, nuclear energy, potential energy (e.g., with a hydroelectric facility), wind energy, and/or chemical energy.

Once generated at the power generation facility 110, the electricity may be delivered to the users 140A-140N via a power distribution grid. The power grid may include, for example, power transmission lines 115 between the power generation facility 110 and one or more substations 120. The electricity may be further transmitted from a given substation 120 to one or more users 140A-140N over electrical distribution circuits 130, also known as feeders. For example, the electrical distribution circuit 130 may provide electricity to any of users 140A-140N via a connection between the electrical distribution circuit 130 and the location (e.g., house or building) of the user, such as, for example, at a power meter. The electrical distribution circuits 130 may include, for example, both overhead and underground power lines. Electrical distribution circuits 130 may include additional segmentation. For example, an electrical distribution circuit 130 may include one or more protective devices 135. Protective devices 135 may include, for example, switches, circuit breakers, and/or reclosers.

There are many benefits to combining the legacy power distribution infrastructure with a corresponding fiber optic network, because doing so unlocks many enhancements to the efficiency and effectiveness of power generation, transmission, distribution, and maintenance. However, combining the use of a dedicated fiber optic network with sensitive power distribution infrastructure introduces new security risks.

For instance, if a component in a fiber optic network is comprised, fraudulent data transfer along the fiber optic network could result in significant exposure to any other entity in the network. When a fiber optic network is combined with the power distribution infrastructure for a region, the risk profile increases substantially. Accordingly, integration of a fiber optic network with power distribution infrastructure requires a concomitant increased in security control.

### BRIEF SUMMARY

Fiber deployment today requires one entity to take responsibility for data and doesn't provide for any security other than standard packet time-division multiplexing (TDM) data transfer. In the era of increasing cyberattacks and the need to increase performance while lowering cost, implementing a security protocol on existing middle-mile wavelength-division multiplexing (WDM) networks will bring general value to the data communications market. Current security is done at the data level. Systems, apparatuses, methods, and computer program products are disclosed herein for providing an additional layer of security to WDM fiber optic networks. As described herein, the security protocol contemplated in embodiments herein may be implemented between physical wavelengths at the infrastructure level all the way to the premise.

An example method for providing for WDM fiber optic network security is disclosed herein. The example method includes transmitting, by a control system, an authentication request to an active device in a fiber optic network, receiving, by the control system, a message from the active device, the message containing a unique identifier and an authentication key, and performing, by the control system, one or more authentication operations using the unique identifier and the authentication key. The method further includes, in an instance in which the authentication operation fails, transmitting, by the control system, an encryption key change message to the active device. The method further includes, in an instance in which the authentication operation succeeds, transmitting, by the control system, a message to the active device authorizing the active device to communicate.

In one example embodiment, an apparatus is provided for WDM fiber optic network security is disclosed herein. The example apparatus includes a processor and a memory storing software instructions that, when executed by the processor, cause the apparatus to transmit an authentication request to an active device in a fiber optic network and receive a message from the active device, the message containing a unique identifier and an authentication key. The processor and a memory storing software instructions that, when executed by the processor, further cause the apparatus to perform one or more authentication operations using the unique identifier and the authentication key. The processor and a memory storing software instructions that, when executed by the processor, further cause the apparatus to, in an instance in which the authentication operation fails, transmit an encryption key change message to the active device. The processor and a memory storing software instructions that, when executed by the processor, further cause the apparatus to, in an instance in which the authentication operation succeeds, transmit, by the control system, a message to the active device authorizing the active device to communicate.

In one example embodiment, a computer program product is provided for WDM fiber optic network security is disclosed herein. The computer program product includes at least one non-transitory computer-readable storage medium storing software instructions that, when executed by an apparatus, cause the apparatus to transmit an authentication request to an active device in a fiber optic network and receive a message from the active device, the message containing a unique identifier and an authentication key. The at least one non-transitory computer-readable storage medium storing software instructions that, when executed by an apparatus, further cause the apparatus to perform one or more authentication operations using the unique identifier and the authentication key. The at least one non-transitory computer-readable storage medium storing software instructions that, when executed by an apparatus, further cause the apparatus to, in an instance in which the authentication operation fails, transmit an encryption key change message to the active device. The at least one non-transitory computer-readable storage medium storing software instructions that, when executed by an apparatus, further cause the apparatus to, in an instance in which the authentication operation succeeds, transmit, by the control system, a message to the active device authorizing the active device to communicate.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to sc ale. Some embodiments may include fewer or more components than those shown in the figures.

FIG. 1 illustrates a simplified block diagram illustrating an example electrical power distribution environment.

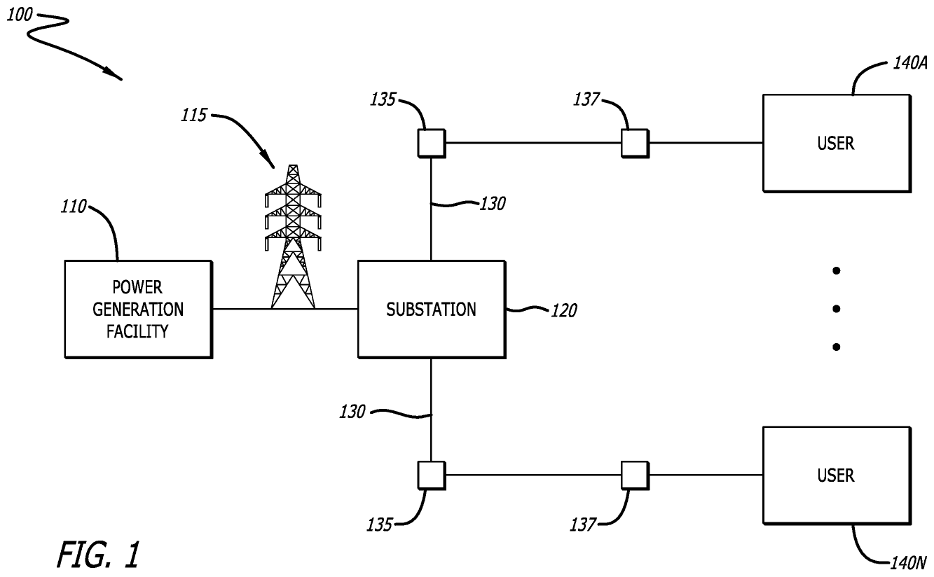

FIG. 2A illustrates a simplified block diagram of an example electrical power distribution environment and corresponding fiber optic network, in accordance with some example embodiments described herein.

FIG. 2B illustrates a simplified block diagram of an example fiber optic network that may be utilized in accordance with some example embodiments described herein.

FIG. 3 illustrates a schematic block diagram of example circuitry embodying a device that may perform various operations in accordance with example embodiments described herein.

FIG. 4 illustrates an example flowchart for WDM security, in accordance with some example embodiments described herein.

FIG. 5 illustrates a swim lane diagram of operations for an example process for WDM security, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly describe herein are also contemplated as may be set forth in some of the appended claims. Although specific terms are employed herein, they are used in a generic and descriptive sense only and not for purposes of limitation.

The terms “data,” “content,” “information,” “electronic information,” “signal,” “command,” and similar terms may be used interchangeably to refer to data capable of being transmitted, received, and/or stored in accordance with embodiments of the present invention. Thus, use of any such terms should not be taken to limit the spirit or scope of embodiments of the present invention. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

The terms “comprising” means including but not limited to, and should be interpreted in the manner it is typically used in the patent context. Use of broader terms such as comprises, includes, and having should be understood to provide support for narrower terms such as consisting of, consisting essentially of, and comprised substantially of.

The terms “in one embodiment,” “according to one embodiment,” “in some embodiments,” and the like generally may refer to the fact that the particular feature, structure, or characteristic following the phrase may be included in at least one embodiment of the present invention. Thus, the particular feature, structure, or characteristic may be included in more than one embodiment of the present invention such that these phrases do not necessarily refer to the same embodiment.

The term “example” is used herein to mean “serving as an example, instance, or illustration.” Any implementation described herein as “example” is not necessarily to be construed as preferred or advantageous over other implementations.

The terms “computer-readable medium” and “memory” refer to non-transitory storage hardware, non-transitory storage device or non-transitory computer system memory that may store computer-executable instructions or software programs that may be accessed by a controller, a microcontroller, a computational system or a module of a computational system. A non-transitory computer-readable medium may be accessed by a computational system or a module of a computational system to retrieve and/or execute the computer-executable instructions or software programs stored on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

The term “computing device” may refer to any computer embodied in hardware, software, firmware, and/or any combination thereof. Non-limiting examples of computing devices include a personal computer, a server, a laptop, a mobile device, a smartphone, a fixed terminal, a personal digital assistant (“PDA”), a kiosk, a custom-hardware device, a wearable device, a smart home device, an Internet-of-Things (“IoT”) enabled device, and a network-linked computing device.

The term “control system” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, server devices, and similar electronic devices equipped with at least a processor and any other physical components necessary to perform the various operations described herein.

The term “fiber optic network” is used herein to refer to a communication network which includes one or more optical fiber cables, which may be used facilitate the transfer of a signal (e.g., telemetry data) between respective terminals (e.g., a starting node or optical line terminal (OLT) and a terminating node or optical network terminal (ONT)). At least a portion of each optical fiber cable may further be disposed within a cable jacket, which may serve to protect the optical fiber cable from environmental conditions and ensure long-term durability. Additionally, the cable jacket may minimize attenuation of carried signals due to microbleeding. In some embodiments, the fiber optic network is a passive optical network (PON). A PON may use one or more fiber optic splitters to divide individual optical fiber cables among two or more ONTs, thus reducing the number of fiber optic cables needed for connectivity and the number of active devices requiring electrical power. A PON may utilize wavelength-division multiplexing (e.g., coarse wavelength division multiplexing (CWDM or dense wavelength division multiplexing (DWDM)) to permit bidirectional communications and/or a multiplication of capacity of the fiber optic network. In some embodiments, downstream signals provided by an ONT are received by all ONTs. In some embodiments, these downstream signals are encrypted using any suitable technique to prevent eavesdropping. In some embodiments, the fiber optic terminals may correspond to terminals at a central office (CO) or head end (HE) facility and customer premise equipment (CPE) at a corresponding customer location, residential government, or commercial location.

The term “telemetry data” is used here to refer to data collected by various devices within the power distribution environment and transmitted via the fiber optic network. For example, the telemetry data may be collected by smart meters at a customer premises, transformers, down-line reclosers, and distributed power generation facilities, and/or the like. Telemetry data may be transmitted via the fiber optic network in sub-millisecond intervals. In some embodiments, the telemetry data may be encrypted using an encryption key. The encryption key may be a symmetric encryption key which is shared between two or more active devices or other devices within the fiber optic network. The encryption key may correspond to a symmetric key algorithm, such as advanced encryption standard (AES), Blowfish, data encryption standard (DES), and/or the like.

### Overview

Example embodiments described herein rely upon an enhanced electrical power distribution environment leveraging the use of a corresponding fiber optic network that permits near-real-time exchange of information between entities in the environment. Reliance on a fiber optic network, however, brings new security concerns to bear. Fiber deployment today requires one entity to take responsibility for data and doesn't provide for any security other than standard packet time-division multiplexing (TDM) data transfer. In the era of increasing cyberattacks and the need to increase performance while lowering cost, implementing a security protocol on existing middle mile WDM networks will bring general value to the data communications market. Current security is done at the data level. This security protocol is implemented between physical wavelengths at the infrastructure level all the way to the premise.

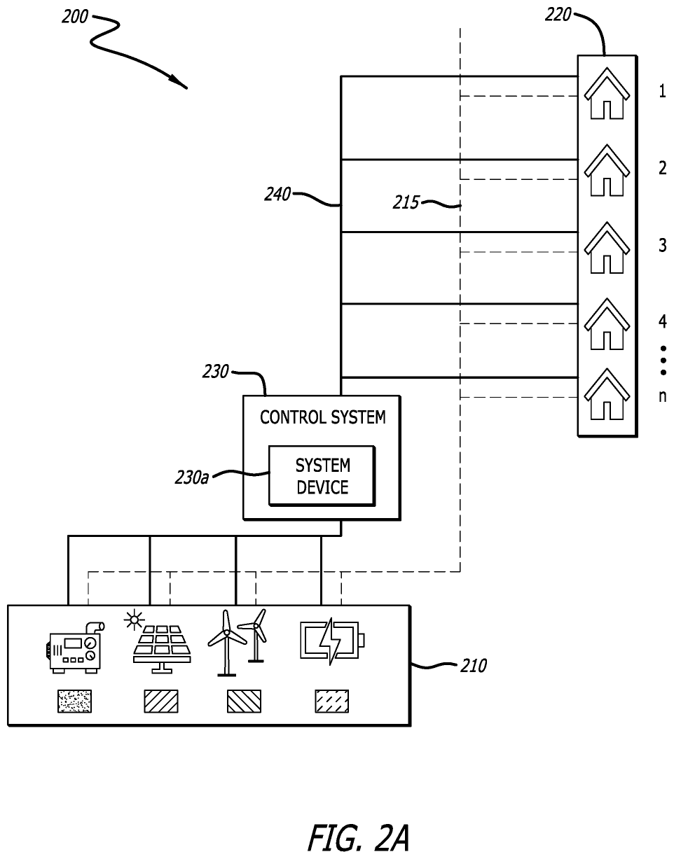

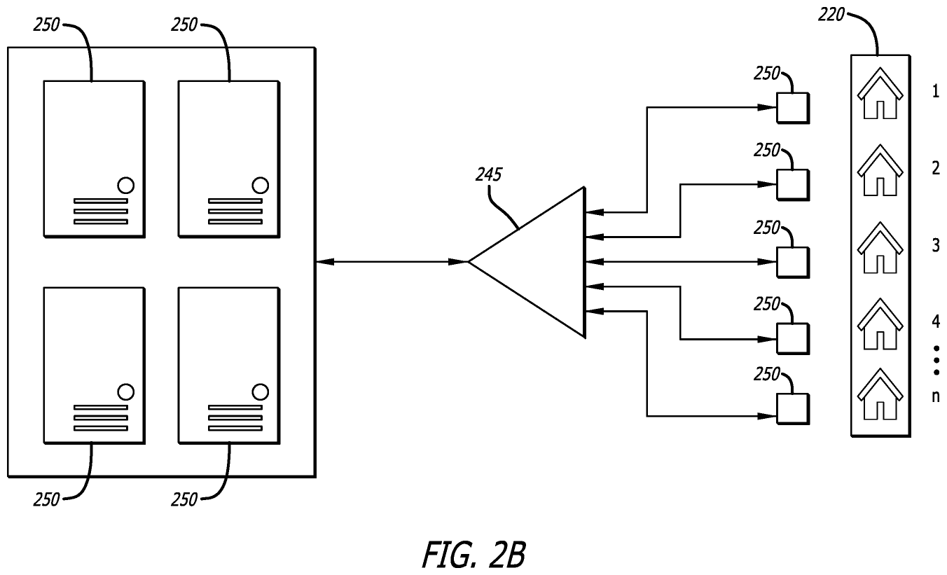

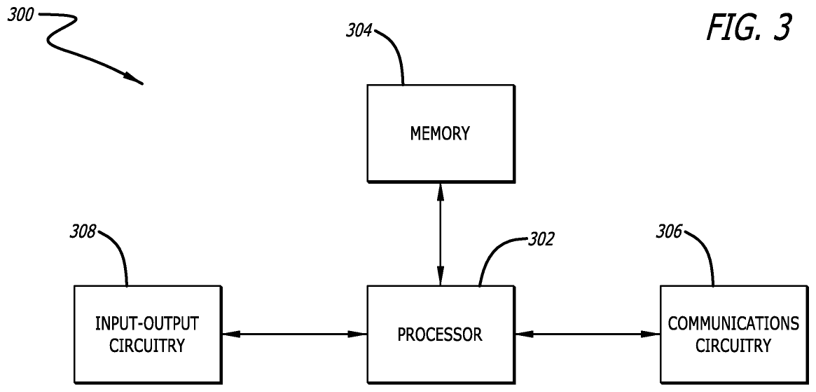

FIG. 2A illustrates a simplified block diagram of an example electrical power distribution environment 200 enhanced by a corresponding fiber optic network, in accordance with some example embodiments described herein. FIG. 2A illustrates a series of power generating facilities 210 (which may comprise facilities that generate electricity from fossil fuels, solar energy, geothermal energy, nuclear energy, potential energy (e.g., with a hydroelectric facility), wind energy, and/or chemical energy.) that may be provide power to a series of users 220 via a distribution network 215. While power generation facilitates 110 are traditionally located in fixed locations within an environment remote from heavily populated areas and connected to the rest of the environment via transmission lines, many renewable power generation facilitates (e.g., wind, solar, fuel-based generators, and battery enclaves) may be distributed throughout the environment. In addition, however, FIG. 2A illustrates a control system 230 that may exchange information with the power generating facilities 210 and the users 220 via a fiber optic network 240. Various components of the control system 230 are described in greater detail below in connection with FIG. 3. The fiber optic network 240 may connect to just the endpoints in the electrical power distribution environment 200 or may connect to all entities (including transformers, switches, circuit breakers, reclosers, etc.) in the electrical power distribution environment 200.

Optical fiber cables within the fiber optic network 240 may be used facilitate the transfer of a signal (e.g., telemetry data) between respective terminals (e.g., between OLT and ONTs). At least a portion of each optical fiber cable may further be disposed within a cable jacket, which may serve to protect the optical fiber cable from environmental conditions and ensure long-term durability. Additionally, the cable jacket may minimize attenuation of carried signals due to microbleeding. Connection of the fiber optic network to the various entities in the electrical power distribution environment 200 enables near-real-time communication between any two entities in the environment with any other entity.

The fiber optic network 240 may comprise a PON to reduce the number of fiber optic strands needed for connectivity and the number of active devices requiring electrical power, and may utilize wavelength-division multiplexing (e.g., CWDM or DWDM) to permit bidirectional communications and/or a multiplication of capacity of the fiber optic network. A PON may use one or more fiber optic splitters to divide individual optical fiber cables among two or more ONTs, thus reducing the number of fiber optic cables needed for connectivity and the number of active devices requiring electrical power. In some embodiments, downstream signals provided by an OLT are received by all ONTs. In some embodiments, the fiber optic terminals may correspond to terminals at the CO or HE located at a facility and/or CPE at the customer location, residential government, or commercial location. In some embodiments, the terminals at the CO or HE may serve as the OLT and terminals at the CPE may serve as the ONT. Alternatively, terminals at the CPE may serve as the OLT and terminals at the CO or HE may serve as the ONT.

The control system 230 leverages the existence of the fiber optic network 240 to receive telemetry data (e.g., small data packets transmitted in sub-millisecond intervals) from various devices in the electrical power distribution environment 200. From this telemetry data, the control system may calculate various results that may be beneficially used for management of the electrical power distribution environment 200. The telemetry data may be encrypted using an encryption key, which may be stored by a respective active device. A system device 230a of the control system or a recipient active device may decrypt the telemetry data using the encryption key stored locally at the control system. In some embodiments, the system device 230a may be implemented as a primary gateway or one or more secondary gateways.

However, as noted previously, integration of a fiber optic network with a legacy power generation infrastructure presents new security vectors that must be defended. Example embodiments mitigate these risks by enabling correlated active security through use of dual keys for each active device in the fiber optic network. As shown in FIG. 2B, active devices subject to the active security implementation contemplated herein include optical terminals 250 at the CO or HE and CPE at a location (e.g., customer, residential, government, or commercial) of users 220. Inactive components of the PON may include one or more splitters (e.g., element 245) utilized throughout the fiber optic network.

Specifically, each active device is assigned two configuration values upon installation. First, each active device receives unique identifier which must contain four values: (i) the Media Access Control (MAC) address of the active device, (ii) an active device serial number, (iii) a location identifier, and (iv) one configurable value. And second, each active device is assigned a set of unique keys which may be initialized at the factory during manufacture for each active device and are registered upon network activation of the active device.

The MAC address and active device serial number may be automatically assigned to the active device by the device manufacturer and hard-coded into the active device's network interface card (NIC). In some embodiments, the location identifier may correspond to an internet protocol (IP) address for the active device which is communicatively coupled to a corresponding communication network (e.g., the internet). In some embodiments, the configurable value may be a random or pseudo-random value which is generated for the particular active device during manufacture. The configurable value may be a combination of alphanumeric characters and/or special characters and the configurable value may be of variable length. The unique identifier may be any combination of the four values. For example, the unique identifier may include each of the four values separated by a delimiter. As another example, the unique identifier may include each of the four values ordered in a particular combination (e.g., a 12 character MAC address followed by a fixed length active device serial number followed by a variable character 32 bit IPv4 address followed by a variable length configurable value).

Additionally, the active device is assigned a set of unique keys during manufacture, which are registered upon network activation of the active device. The set of unique keys may include at least a first key and a second key. The first key may be an authentication key that can be used to verify the identity of the active device on the network. The second key may be an encryption key used to encrypt and/or decrypt telemetry data transmitted by the active device or received from other devices across the fiber optic network.

The set of unique keys for each active device of the entire network may be maintained in a primary gateway and one or more secondary gateways for the entire network and initiate all communication with devices on the network. In some embodiments, the primary gateway and one or more secondary gateways may also store the unique identifier for each active device in the fiber optic network 240. In some embodiments, the primary gateway and one or more secondary gateways may store the unique identifier with a corresponding set of unique keys for the active device such that the corresponding gateway may use the unique identifier to locate and/or query the set of unique keys for the active device. The primary gateway and one or more secondary gateways may be associated with control system 230.

The primary gateway may store the originally initialized set of unique keys for each active device of the entire network. Physical access control to the primary gateway requires extreme security measures, such as multifactor authentication (MFA) security measures to ensure only authorized personnel have access to the primary gateway.

Each secondary gateway may store a copy of the set of unique keys for each active device of the entire network. Thus, each secondary gateway may provide for resiliency measures by storing a copy of the set of unique keys in the event the primary gateway becomes disconnected from the network, experiences connection disruptions, or otherwise fails to provide a key from the stored set of unique keys. A secondary gateway may be promoted to a primary gateway in the event of a catastrophic failure to the extant primary gateway. In order to be promoted to a primary gateway, the secondary gateway may be dually authorized from different locations. In some embodiments, a minimum number of secondary gateways are required for operation of the network. For example, three secondary gateways which are geographically diverse may be required to bring and/or maintain fiber optic network communication.

The authentication key may be used to verify the identity of the active device on the network. In some embodiments, the authentication key may be a digital signature or password associated with the active device. The authentication key may be a unique combination of alphanumeric characters and/or special characters which is assigned to the particular unique identifier corresponding to the active device. The authentication key may be stored by the primary gateway and one or more secondary gateways as described above. Additionally, the active device may be configured to store the authentication key locally. In some embodiments, the active device may store the authentication key in an encrypted form using any suitable encryption such that it is stored securely.

The encryption key may be used to encrypt data transmitted by the active device across the fiber optic network. The authentication key may be stored by the primary gateway and one or more secondary gateways as described above. Additionally, the active device may be configured to store the encryption key locally. The encryption key may be a symmetric encryption key which is shared between two or more active devices within the fiber optic network. The encryption key may correspond to a symmetric key algorithm, such as advanced encryption standard (AES), Blowfish, data encryption standard (DES), and/or the like. As such, a provisioning active device may use the encryption key to encrypt telemetry data and a recipient device, such as a recipient active device, may decrypt the telemetry data using a corresponding encryption key which is locally accessible to the recipient device.

After device activation, each key for the active device is stored by the primary gateway and on or more secondary gateways such that each key is only updatable by a primary gateway or secondary gateway. Keys may be changed randomly by a primary gateway or secondary gateway based on configuration parameter set by a network operator. A configuration parameter may define a periodic time value for which the primary gateway or one or more secondary gateways may be configured to automatically change either the authentication key, encryption key, or both based on the periodic time value. For example, the periodic time value may be one week such that the primary gateway may be configured to generate a new encryption key and authentication key every week for each active device. A security risk configuration may additionally or alternatively occur in response to a loss of connection for an active device for a predetermined time period (e.g., connection loss longer than one hour), in response to an active device timeout request (e.g., an active device has exceeded a given response time threshold), or in response to a manual request received from an authorized user who is authenticated via associated user authentication credentials.

During remote device authentication by control system 230, the primary gateway and/or one or more secondary gateways may be automatically triggered to query the stored set of unique keys for one or more keys corresponding to the active device using a corresponding unique identifier. As such, control system 230 may be configured to decrypt a message from the active device using an encryption key and perform one or more authentication operations using corresponding active device information (e.g., an authentication key and unique identifier).

Using this design, example implementations contemplated herein mitigate cybersecurity risk for the fiber optic network. For instance, example implementations enable a control system to use a primary gateway or secondary gateway to randomly authenticate and validate an active device using associated active device keys (e.g., an authentication key) during operation. Active device keys may be regenerated and updated based on configuration by the network operator and thus, facilitates immediate recognition of attempts to clone or impersonate an active device. In some embodiments, all CPE is required to employ Lambda blocking filter commands to allow data to exit on the customer-facing side of the network via a single wavelength (thus shielding communications transmitted over other wavelengths).

Although a high level explanation of the operations of example embodiments has been provided above, specific details regarding the configuration of such example embodiments are provided below.

### Example Implementing Apparatuses

FIG. 3 illustrates an apparatus 300 that may comprise an example system device 230a of control system 230 that may implement example embodiments described herein. The apparatus may include processor 302, memory 304, communications circuitry 306, and input-output circuitry 308, each of which will be described in greater detail below, along with and any number of additional hardware components not expressly shown in FIG. 3. While the various components are only illustrated in FIG. 3 as being connected with processor 302, it will be understood that the apparatus 300 may further comprises a bus (not expressly shown in FIG. 3) for passing information amongst any combination of the various components of the apparatus 300. The apparatus 300 may be configured to execute various operations described above, as well as those described below in connection with FIG. 3.

The processor 302 (and/or co-processor or any other processor assisting or otherwise associated with the processor) may be in communication with the memory 304 via a bus for passing information amongst components of the apparatus. The processor 302 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 300, remote or “cloud” processors, or any combination thereof.

The processor 302 may be configured to execute software instructions stored in the memory 304 or otherwise accessible to the processor (e.g., software instructions stored on a separate storage device). In some cases, the processor may be configured to execute hard-coded functionality. As such, whether configured by hardware or software methods, or by a combination of hardware with software, the processor 302 represent an entity (e.g., physically embodied in circuitry) capable of performing operations according to various embodiments of the present invention while configured accordingly. Alternatively, as another example, when the processor 302 is embodied as an executor of software instructions, the software instructions may specifically configure the processor 302 to perform the algorithms and/or operations described herein when the software instructions are executed.

Memory 304 is non-transitory and may include, for example, one or more volatile and/or non-volatile memories. In other words, for example, the memory 304 may be an electronic storage device (e.g., a computer readable storage medium). The memory 304 may be configured to store information, data, content, applications, software instructions, or the like, for enabling the apparatus to carry out various functions in accordance with example embodiments contemplated herein.

The communications circuitry 306 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 306 may include, for example, a network interface for enabling communications with a wired or wireless communication network. For example, the communications circuitry 306 may include one or more network interface cards, antennas, buses, switches, routers, modems, and supporting hardware and/or software, or any other device suitable for enabling communications via a network. Furthermore, the communications circuitry 306 may include the processing circuitry for causing transmission of such signals to a network or for handling receipt of signals received from a network.

The apparatus 300 may include input-output circuitry 308 configured to provide output to a user and, in some embodiments, to receive an indication of user input. It will be noted that some embodiments will not include input-output circuitry 308, in which case user input may be received via a separate device. The input-output circuitry 308 may comprise a user interface, such as a display, and may further comprise the components that govern use of the user interface, such as a web browser, mobile application, dedicated client device, or the like. In some embodiments, the input-output circuitry 308 may include a keyboard, a mouse, a touch screen, touch areas, soft keys, a microphone, a speaker, and/or other input/output mechanisms. The input-output circuitry 308 may utilize the processor 302 to control one or more functions of one or more of these user interface elements through software instructions (e.g., application software and/or system software, such as firmware) stored on a memory (e.g., memory 304) accessible to the processor 302.

In some embodiments, various components of the apparatus 300 may be hosted remotely (e.g., by one or more cloud servers) and thus not all components must reside in one physical location. Moreover, some of the functionality described herein may be provided by third party circuitry. For example, apparatus 300 may access one or more third party circuitries via any sort of networked connection that facilitates transmission of data and electronic information between the apparatus 300 and the third party circuitries. In turn, the apparatus 300 may be in remote communication with one or more of the components describe above as comprising the apparatus 300.

As will be appreciated based on this disclosure, some example embodiments may take the form of a computer program product comprising software instructions stored on at least one non-transitory computer-readable storage medium (e.g., memory 304). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 300 as described in FIG. 3, that loading the software instructions onto a computing device or apparatus produces a special-purpose machine comprising the means for implementing various functions described herein.

Having described specific components of the apparatus 300, example embodiments are described below.

### Example Operations

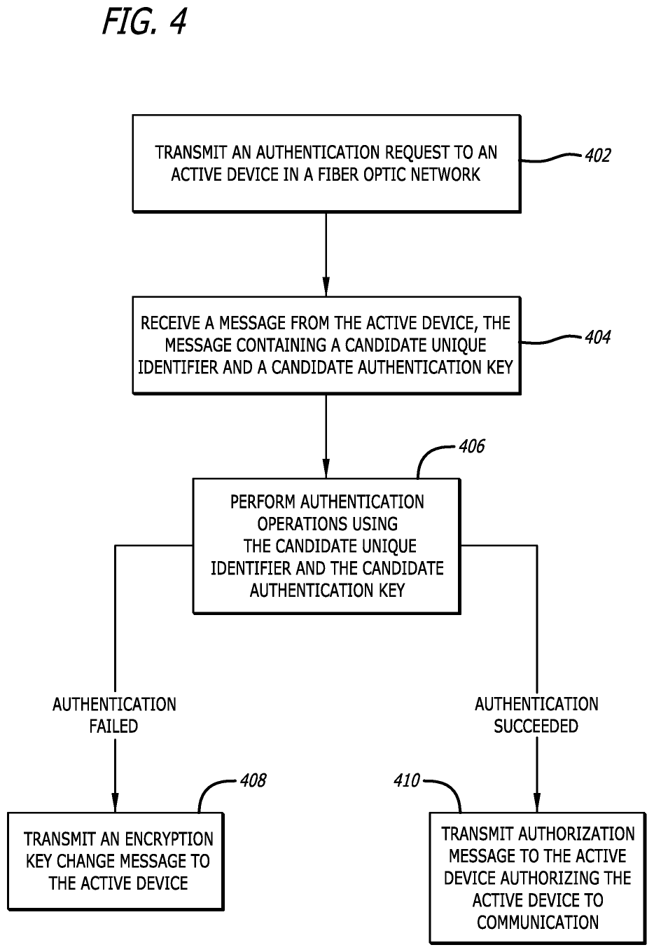

Turning to FIG. 4, an example flowchart is illustrated that contains example operations implemented by various embodiments contemplated herein. The operations illustrated in FIG. 4 may, for example, be performed by an apparatus 300, which is shown and described in connection with FIG. 3. In some embodiments, apparatus 300 may be implemented as control system 230 and/or system device 230a as shown and described in connection with FIGS. 2A-2B. To perform the operations described below, the apparatus 300 may utilize one or more of processor 302, memory 304, communications circuitry 306, input-output circuitry 308, other components, and/or any combination thereof. It will be understood that user interaction with the apparatus 300 may occur directly via input-output circuitry 308, or may instead be facilitated by a device that in turn interacts with apparatus 300.

As shown by operation 402, the apparatus 300 includes means, such as processor 302, memory 304, communications circuitry 306, input-output circuitry 308, or the like, for transmitting an authentication request to an active device in a fiber optic network. In some embodiments, the authentication request is provided to active device corresponding to a terminal at a CPE, CO, or HE located at a customer premise, government residence, commercial facility, etc. The authentication request may be indicative of a request for the recipient active device to authenticate itself. Receipt of the authentication request may cause the active device to provide a message which includes a unique identifier and authentication key for the recipient active device.

In some embodiments, the apparatus 300 may periodically or semi-periodically provide the authentication request to the active device. In particular, the apparatus 300 may provide the authentication request in response to a periodic trigger configured to trigger the apparatus to generate and transmit the authentication alert at predefined intervals. For example, the periodic trigger may be a value of one day such that the apparatus generates and transmits an authentication request to the active device daily. Alternatively, the apparatus 300 may also provide the authentication request in response to another trigger, such as a manual request or in the event another active device within the fiber optic network fails authentication.

As shown by operation 404, the apparatus 300 includes means, such as processor 302, memory 304, communications circuitry 306, input-output circuitry 308, or the like, for receiving a message from the active device. The message may contain a candidate unique identifier and a candidate authentication key as provided by the active device. In some embodiments, the message may be received in response to transmitting the authentication request to the active device.

In some embodiments, at least a portion of the contents of the message may be encrypted. The content may be encrypted using an encryption key associated with the active device. As such, apparatus 300 may be configured to use a corresponding encryption key associated with the active device, which may be securely stored by apparatus 300 or otherwise accessible to apparatus 300, to decrypt the contents of the message. In some embodiments, the encryption key may be a symmetric encryption key which is shared between two or more active devices within the fiber optic network. The encryption key may correspond to a symmetric key algorithm, such as advanced encryption standard (AES), Blowfish, data encryption standard (DES), and/or the like.

In some embodiments, the apparatus 300 may be automatically triggered to query a stored set of unique keys for one or more keys corresponding to the active device using a corresponding unique identifier. In particular, apparatus 300 may be configured to query the stored set of unique keys using the unique identifier associated with the active device to determine active device information, such as the encryption key and authentication key corresponding to the active device.

As shown by operation 406, the apparatus 300 includes means, such as processor 302, memory 304, communications circuitry 306, input-output circuitry 308, or the like, for performing one or more authentication operations using the candidate unique identifier and the candidate authentication key. In some embodiments, the one or more authentication operations may include i) comparing the candidate unique identifier received in the message from the active device to a stored unique identifier and ii) comparing the candidate authentication key received in the message from the active device to a corresponding stored authentication key. Apparatus 300 may then determine whether the candidate unique identifier matches the stored unique identifier and the candidate authentication key matches the stored authentication key. In an instance the candidate unique identifier matches the stored unique identifier and the candidate authentication key matches the stored authentication key, the active device is authentication. Otherwise, the active device fails authentication.

In an instance the active device fails authentication, the process proceeds to operation 408. As shown by operation 408, the apparatus 300 includes means, such as processor 302, memory 304, communications circuitry 306, input-output circuitry 308, or the like, for in an instance in which the authentication operation fails, transmitting an encryption key change message to the active device. In some embodiments, the encryption key change message comprises instructions to cause the active device to terminate use one or more of an existing encryption key or existing authentication key. The existing encryption key and existing authentication key may correspond to currently configured key values at the active device.

In some embodiments, the apparatus 300 transmit an encryption key change message based on a configuration parameter. A configuration parameter may define a periodic time value for which the apparatus 300 may be configured to automatically change either the authentication key, encryption key, or both based on the periodic time value. For example, the periodic time value may be one week such that the apparatus 300 may be configured to generate a new encryption key and authentication key every week for each active device. A security risk configuration may additionally or alternatively occur in response to a loss of connection of an active device for a predetermined time period (e.g., connection loss longer than one hour), in response to an active device timeout request (e.g., an active device has exceeded a given response time threshold), or in response to a manual request received from an authorized user who is authenticated via associated user authentication credentials.

In an instance the active device is successfully authenticated, the process proceeds to operation 410. As shown by operation 410, the apparatus 300 includes means, such as processor 302, memory 304, communications circuitry 306, input-output circuitry 308, or the like, for in an instance in which the authentication operation succeeds, transmitting, by the control system, a message to the active device authorizing the active device to communicate. Once the active device is authenticate, the apparatus 300 may transmit an authorization message to the active device indicating that the active device has been authenticated. The authorization message may include instructions configured to cause the active device to start or maintain communication with other devices within the fiber optic network.

FIG. 4 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### Example System Operations

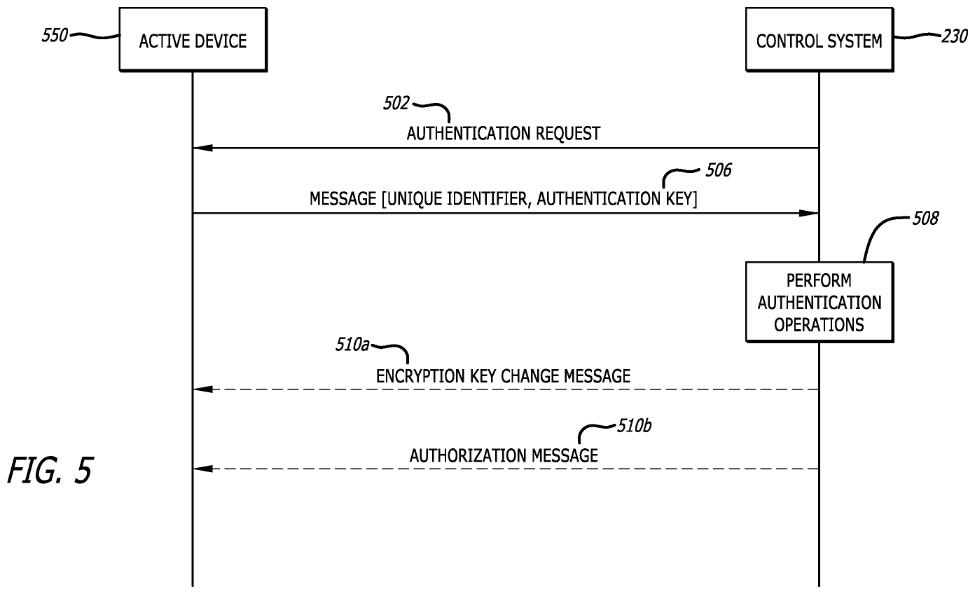

FIG. 5 shows a swim lane diagram illustrating example operations (e.g., as described above in connection with FIG. 4) performed by components of the environment depicted in FIGS. 2A-2B to produce various benefits from example embodiments. In these figures, operations performed by a control system 230 are shown along the vertical line extending from the element labeled “control system” and operations performed by active device 550 are shown along the vertical line extending from the element labeled “active device.” Operations impacting both devices, such as data transmissions between the devices, are shown using arrows extending between these lines. Generally, the operations are ordered temporally with respect to one another. However, it will be appreciated that the operations may be performed in other orders from those illustrated herein.

At operation 502, a control system 230 may provide an authentication request to active device 550. At operation 504, active device 550 may provide a message containing a candidate unique identifier and candidate authentication key to control system 230. At least a portion of the message may be encrypted using an encryption key corresponding to active device 550. At operation 506, control system 230 may perform one or more authentication operations. The one or more authentication operations may determine whether the active device 550 is successfully authenticated or fails authentication. In the instance active device 550 fails authentication, the control system 230 may perform operation 510a and provide an encryption key change message to active device 550. In the instance active device 550 is successfully authenticated, the control system 230 may perform operation 510b and provide an authorization message to active device 550.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for wavelength division multiplexing (WDM) security, the method comprising:
transmitting, by a control system, an authentication request to an active device in a fiber optic network;
receiving, by the control system, a message from the active device, the message comprising a candidate unique identifier and a candidate authentication key;
performing, by the control system, one or more authentication operations based on the candidate unique identifier and the candidate authentication key;
in an instance in which the active device is fails to be authenticated, transmitting, by the control system, an encryption key change message to the active device; and
in an instance in which the active device is authenticated, transmitting, by the control system, a message to the active device authorizing the active device to communicate.

2. The method of claim 1, wherein the received message is encrypted.

3. The method of claim 2, further comprising decrypting, by the control system, the received message using an encryption key associated with the active device.

4. The method of claim 1, further comprising querying, by the control system, a stored set of unique keys for an authentication key corresponding to a unique identifier associated with the active device.

5. The method of claim 1, further comprising querying, by the control system, a stored set of unique keys for an encryption key corresponding to a unique identifier associated with the active device.

6. The method of claim 1, wherein performing the one or more authentication operations further comprises:
comparing, by the control system, the candidate unique identifier to a stored unique identifier corresponding to the active device;
comparing, by the control system, the candidate authentication key to a stored authentication key corresponding to the active device;
determining, by the control system, whether the candidate unique identifier matches the stored unique identifier and the candidate authentication key matches the stored authentication key; and
in an instance the candidate unique identifier matches the stored unique identifier and the candidate authentication key matches the stored authentication key, authenticating, by the control system, the active device.

7. The method of claim 1, wherein the active device is an optical terminal located at a central office, head end, or customer premise.

8. The method of claim 1, wherein a unique identifier is a combination of one or more of a media access control address of the active device, an active device serial number, a location identifier, and a configurable value.

9. The method of claim 1, wherein the encryption key change message comprises instructions to cause the active device to terminate use one or more of an existing encryption key or existing authentication key.

10. The method of claim 9, wherein the encryption key change message further comprises one or more of a new encryption key or new authentication key for the active device.

11. The method of claim 1, further comprising:
generating, by the control system, a new unique key set for the active device, wherein the new unique key set comprises a new encryption key and new authentication key; and
storing, by the control system, the new unique key set as associated with a unique identifier corresponding to the active device.

12. The method of claim 11, wherein the new unique key set is generated in response to determining the active device fails to be authenticated or in response to a configuration parameter.

13. The method of claim 12, wherein the configuration parameter defines a periodic time value configured to describe a time within which one or more keys of a unique key set for the active device must be changed.

14. The method of claim 1, wherein the message is received via a fiber optic network.

15. The method of claim 14, wherein the telemetry data is received via passive-optical networking.

16. An apparatus for wavelength division multiplexing (WDM) security, the apparatus comprising a processor and a memory storing software instructions that, when executed by the processor, cause the apparatus to:
transmit an authentication request to an active device in a fiber optic network;
receive a message from the active device, the message comprising a candidate unique identifier and a candidate authentication key;
perform one or more authentication operations based on the candidate unique identifier and the candidate authentication key;
in an instance in which the active device is fails to be authenticated, transmit an encryption key change message to the active device; and
in an instance in which the active device is authenticated, transmit a message to the active device authorizing the active device to communicate.

17. The apparatus of claim 16, wherein the received message is encrypted.

18. The apparatus of claim 17, the processor and the memory storing software instructions that, when executed by the processor, further cause the apparatus to decrypt the received message using an encryption key associated with the active device.

19. The apparatus of claim 16, the processor and the memory storing software instructions that, when executed by the processor, further cause the apparatus to query a stored set of unique keys for an authentication key corresponding to a unique identifier associated with the active device.

20. A computer program product for wavelength division multiplexing (WDM) security, the computer program product comprising at least one non-transitory computer-readable storage medium storing software instructions that, when executed by an apparatus, cause the apparatus to:
transmit an authentication request to an active device in a fiber optic network;
receive a message from the active device, the message comprising a candidate unique identifier and a candidate authentication key;
perform one or more authentication operations based on the candidate unique identifier and the candidate authentication key;
in an instance in which the active device is fails to be authenticated, transmit an encryption key change message to the active device; and
in an instance in which the active device is authenticated, transmit a message to the active device authorizing the active device to communicate.
